(19) United States
(12) Patent Application Publication
(10) Pub. No.: US 2025/0263153 A1
(43) Pub. Date: Aug. 21, 2025

(54) METHOD AND SYSTEM FOR PREDICTING EQUIVALENT SCOUR DEPTHS OF OFFSHORE ENGINEERING STRUCTURE

(71) Applicants: Zhejiang Huadong Mapping and Engineering safety Technology CO., LTD., Hangzhou (CN); Ocean University of China, Qingdao City (CN)

(72) Inventors: Qiang Liu, Hangzhou (CN); Fushun Liu, Hangzhou (CN); Xiaoming Zhan, Hangzhou (CN); Shuang Chang, Hangzhou (CN)

(21) Appl. No.: 18/612,238

(22) Filed: Mar. 21, 2024

(30) Foreign Application Priority Data
Feb. 21, 2024 (CN) 2024101905936

(51) Int. Cl. B63B 79/30; B63B 71/10; G01V 20/00

(52) U.S. Cl. CPC B63B 79/30; B63B 71/10; G01V 20/00

(57) ABSTRACT

The present disclosure relates to the technical field of condition monitoring on offshore engineering structures, in particular to a method and system for predicting equivalent scour depths of an offshore engineering structure. The method includes: acquiring vibration accelerations at different wave measuring points above a water surface of the offshore engineering structure and extracting first-order frequencies and first-order displacement vectors thereof at different wave measuring points; respectively establishing equivalent constraint finite element models based on different fixed constraint positions below a mud surface; analyzing the models to obtain first-order frequencies of the models and first-order shape vectors at all the wave measuring points for compiling a finite element model database; and matching the first-order frequencies and the first-order displacement vectors of the offshore engineering structure with the finite element model database respectively, and obtaining predicted values of the equivalent scour depths via calculation based on a matching result.

### CROSS REFERENCE TO RELATED APPLICATION

This application claims priority to Chinese Patent Application No. 2024101905936, filed Feb. 21, 2024, the entire disclosure of which is incorporated herein by reference in its entirety.

### TECHNICAL FIELD

The present disclosure relates to the technical field of condition monitoring on offshore engineering structures, in particular to a method and system for predicting equivalent scour depths of an offshore engineering structure.

### BACKGROUND ART

Offshore engineering structures refer to various engineering structures used for energy exploitation, offshore engineering construction or other offshore activities in marine environments, and pile foundation type offshore engineering structures are one of common structural types, and mainly used for offshore drilling platforms, offshore wind generating sets and the like. In view of the pile foundation type offshore engineering structures, and when currents flow through pile foundations of the offshore engineering structures, surrounding local flow fields change due to the existence of the pile foundations, resulting in local scour around the pile foundations. With the increase in scour depths, cantilever lengths of piles will be usually increased due to the decrease in embedding depths of the pile foundations in soil, resulting in the decrease in bearing capacity of the pile foundations, which leads to the decrease in inherent frequencies of the structures and the increase of dynamic response, and even resonance of the structures. Therefore, monitoring scour conditions of the offshore engineering structures and accurately assessing influences of scour on bearing capacity of pile foundation structures are of great engineering significance for ensuring safe operation of the offshore engineering structures.

At present, monitoring scour on the offshore engineering structures mainly relies on operation and maintenance vessels regularly performing sweeping surveys through multi-beam equipment, so as to obtain the evolution of scour pits around the piles. However, large limitations still exist in an existing scour monitoring means for the offshore engineering structures, specifically, on the one hand, the current monitoring means can only rely on regular sweeping surveys due to the limitation of cost and test conditions, is restricted by weather conditions, and has long monitoring cycle and high cost, the monitoring range is limited by the movement range of operation and maintenance vessels, with poor accessibility, especially, as offshore distances of offshore engineering structures increase, the operation and maintenance time is longer, the cost is higher, and the requirement for operation and maintenance window periods is higher, resulting in great challenges to scour monitoring of the offshore engineering structures. On the other hand, offshore engineering structures with different geological conditions and different pile foundation dimensions have different degrees of influence under the same scour depth. However, the scour depth obtained by sweeping surveys through the existing scour monitoring means cannot reflect the real constraint change of the pile foundation structures, resulting in the inability to accurately assess the influences of scour on the bearing capacity of the pile foundation structures, which is not conducive to the assessment of safe states of the offshore engineering structures.

### SUMMARY

In view of the above technical problems, the present disclosure provides a method and system for predicting equivalent scour depths of an offshore engineering structure, which can achieve real-time monitoring of scour depths, solve the technical problem that the scour depths hardly reflect the real constraint change of a pile foundation structure, and meanwhile improve the reliability of equivalent scour depth prediction.

Therefore, the present disclosure provides the following technical solution: A method for predicting equivalent scour depths of an offshore engineering structure, includes the following steps:
step S1, arranging a plurality of acceleration sensors at different positions above a water surface of the offshore engineering structure as wave measuring points to acquire vibration accelerations at different wave measuring points;
step S2, extracting first-order frequencies of the offshore engineering structure and first-order displacement vectors thereof at different wave measuring points based on the vibration accelerations at different wave measuring points;
step S3, respectively establishing equivalent constraint finite element models based on different fixed constraint positions below a mud surface of the offshore engineering structure, wherein the equivalent constraint finite element models are used for equivalently transforming pile-soil constraints of the offshore engineering structure into fixed constraints on the bottom of the foundation;
step S4, performing modal analysis on the equivalent constraint finite element models to obtain first-order frequencies of the equivalent constraint finite element models and first-order shape vectors at all the wave measuring points, wherein a finite element model database is compiled from the first-order frequencies and the first-order shape vectors of all the equivalent constraint finite element models;
step S5, matching the first-order frequencies and the first-order displacement vectors of the offshore engineering structure with the first-order frequencies and the first-order shape vectors in the finite element model database respectively, and obtaining predicted values of the equivalent scour depths via calculation based on a matching result.

Wherein, the first-order frequencies refer to fundamental vibration frequencies of the offshore engineering structure during vibration, which are inherent frequencies of a structural system and reflect fundamental vibration characteristics of the structure during vibration. First-order displacements refer to displacement components in a case where the offshore engineering structure vibrates at the first-order frequencies as vibration frequencies, which reflect a vibration magnitude of the structure at the first-order frequencies. The first-order displacement vectors are formed by a set of the first-order displacements at the same moment and different positions. Both the first-order frequencies and the first-order displacements can reflect vibration characteristics and dynamic response characteristics of the structure. Finite element models are engineering analysis methods used for performing numerical analysis and simulation on structures, parts or systems. First-order shapes refer to vibration patterns in a case where the offshore engineering structure vibrates at the first-order frequencies. The first-order shape vectors are formed by a set of the first-order shapes at different positions.

A technical concept of the present disclosure is as follows: On the basis of the constraint change of a pile foundation of the offshore engineering structure caused by scour, resulting in changes in vibration response characteristics of the structure, in the present disclosure, firstly, the plurality of acceleration sensors are arranged at different positions above the water surface of the offshore engineering structure as the wave measuring points to measure dynamic response of the structure under the action of wind waves and other marine environments and acquire the vibration accelerations at different wave measuring points, such that the first-order frequencies and the first-order displacements that reflect dynamic characteristics of the structure are extracted therefrom; secondly, the pile-soil constraints represent constraints of soil mass on the pile foundation of the offshore engineering structure, the pile foundation of the offshore engineering structure is embedded into soil of a sea bed, which bears a weight and external loads of the structure through interaction with the soil mass, however, analysis on the interaction between piles and soil and simulation on the soil mass are complex, therefore, the equivalent constraint finite element models are established respectively based on different fixed constraint positions below the mud surface of the offshore engineering structure, the pile-soil constraints are equivalently transformed into the fixed constraints, namely, equivalent constraint positions, on the bottom of the foundation below the mud surface based on a dynamic equivalence principle, and the real constraint change of the pile foundation caused by loss of the soil mass around the piles caused by scour is measured by change in the equivalent constraint positions; then, modal analysis is performed on the equivalent constraint finite element models, to obtain the first-order frequencies of the equivalent constraint finite element models and the first-order shape vectors at all the wave measuring points, the finite element model database is compiled from the first-order frequencies and the first-order shape vectors of all the equivalent constraint finite element models, that is, the finite element model database includes the equivalent constraint finite element models, equivalent constraint positions, first-order frequencies and first-order shape vectors, all of which correspond to one another one by one, thereby providing a quantization basis for subsequently predicting the equivalent scour depths reflecting the constraint change of the pile foundation caused by scour; and finally, the first-order frequencies and the first-order displacement vectors of the offshore engineering structure match with the first-order frequencies and the first-order shape vectors in the finite element model database respectively, that is, the first-order frequencies and the first-order displacement vectors of the offshore engineering structure match with the equivalent constraint finite element models, equivalent constraint positions, first-order frequencies and first-order shape vectors that are in one-to-one correspondence in the finite element model database respectively, and the predicted values of the equivalent scour depths capable of reflecting the real constraint change of the pile foundation structure are obtained via quantitative calculation based on the equivalent constraint positions obtained via matching.

As a preference, respectively establishing equivalent constraint finite element models based on different fixed constraint positions below a mud surface of the offshore engineering structure in step S3, includes:
setting a bottom fixed constraint of one equivalent constraint finite element model, adopting a bottom end of a pile foundation of the offshore engineering structure as an initial fixed constraint position, and establishing the equivalent constraint finite element model based on the initial fixed constraint position;
moving the bottom fixed constraint a preset constraint distance towards the mud surface along the pile foundation, and establishing the equivalent constraint finite element model based on a current fixed constraint position; and
repeating the previous step till the current fixed constraint position reaches the mud surface of the offshore engineering structure, to obtain the equivalent constraint finite element models corresponding to all the fixed constraint positions.

As a preference, an expression of the fixed constraint position of the equivalent constraint finite element model is:

$$L ( j ) = {L}_{0} + ( j - 1 ) Δ L , j = 1 , 2 , , q$$

where, L(j) represents the fixed constraint position of the equivalent constraint finite element model, L₀ represents the initial fixed constraint position, j represents an index of the equivalent constraint finite element model, ΔL represents the preset constraint distance of movement, and q represents the total number of the equivalent constraint finite element models.

As a preference, matching the first-order frequencies and the first-order displacement vectors of the offshore engineering structure with the first-order frequencies and the first-order shape vectors in the finite element model database respectively, and obtaining predicted values of the equivalent scour depths via calculation based on a matching result in step S5, include:
matching the first-order frequencies of the offshore engineering structure with the first-order frequencies in the finite element model database, and determining first equivalent constraint positions based on a matching result;
matching the first-order displacement vectors of the offshore engineering structure with the first-order shape vectors in the finite element model database, and determining second equivalent constraint positions based on a matching result; and
obtaining the predicted values of the equivalent scour depths via calculation based on the first equivalent constraint positions and the second equivalent constraint positions.

As a preference, matching the first-order frequencies of the offshore engineering structure with the first-order frequencies in the finite element model database, and determining first equivalent constraint positions based on a matching result, include:
calculating relative errors between the first-order frequencies of the offshore engineering structure and the first-order frequencies in the finite element model database one by one, and determining indexes of the equivalent constraint finite element models corresponding to the current first-order frequencies in the finite element model database when the relative error is the minimum; and
obtaining fixed constraint positions of the equivalent constraint finite element models determined based on a first-order frequency matching result according to the indexes, and marking as the first equivalent constraint positions.

As a preference, matching the first-order displacement vectors of the offshore engineering structure with the first-order shape vectors in the finite element model database, and determining second equivalent constraint positions based on a matching result, include:
normalizing the first-order displacement vectors of the offshore engineering structure and the first-order shape vectors in the finite element model database;
calculating relative errors between normalized first-order displacements of the offshore engineering structure and normalized first-order shapes in the finite element model database one by one, and determining indexes of the equivalent constraint finite element models corresponding to the current first-order shapes when the relative error is the minimum; and
obtaining fixed constraint positions of the equivalent constraint finite element models determined based on a first-order displacement matching result according to the indexes, and marking as the second equivalent constraint positions.

Wherein, normalization is a data preprocessing method that aims at transforming different vectors into a normalized form by dividing values of the vectors by a reference value, achieving comparability of different variables or data at different wave measuring points.

As a preference, normalizing the first-order displacement vectors of the offshore engineering structure and the first-order shape vectors in the finite element model database, includes:
normalizing the first-order displacement vectors of the offshore engineering structure based on first-order displacements, extracted at the wave measuring point closest to the water surface, of the offshore engineering structure; and
normalizing the first-order shape vector of each equivalent constraint finite element model in the finite element model database based on the first-order shape, obtained at the wave measuring point closest to the water surface, of each equivalent constraint finite element model.

As a preference, obtaining the predicted values of the equivalent scour depths via calculation based on the first equivalent constraint positions and the second equivalent constraint positions, includes:
performing weighted summation on the first equivalent constraint positions and the second equivalent constraint positions, to obtain equivalent constraint positions that take the first-order frequencies and the first-order displacements into account at the same time, and marking as the predicted values of the equivalent scour depths.

As a preference, the method further includes the following steps after step S5:
periodically acquiring a plurality of vibration accelerations at each wave measuring point within one day, and performing step S1 to step S5, to obtain predicted values of a plurality of equivalent scour depths within one day;
the normal probability density function is used for fitting the predicted values of the plurality of equivalent scour depths within one day, to obtain a fitting curve for the equivalent scour depths on the same day;
adopting the equivalent scour depth corresponding to a maximum probability in the fitting curve as a statistically predicted value of the equivalent scour depths on the same day; and
determining a change relationship of the equivalent scour depths over time based on the periodically obtained statistically predicted value of the equivalent scour depths.

A system for predicting equivalent scour depths of an offshore engineering structure, includes:
a measured data acquisition module, configured to arrange a plurality of acceleration sensors at different positions above a water surface of the offshore engineering structure as wave measuring points to obtain vibration accelerations at different wave measuring points;
a measured feature extraction module, configured to extract first-order frequencies of the offshore engineering structure and first-order displacement vectors thereof at different wave measuring points based on the vibration accelerations at different wave measuring points;
a model establishment module, configured to respectively establish equivalent constraint finite element models based on different fixed constraint positions below a mud surface of the offshore engineering structure, wherein the equivalent constraint finite element models are used for equivalently transforming pile-soil constraints of the offshore engineering structure into fixed constraints on the bottom of the foundation;
a database establishment module, configured to perform modal analysis on the equivalent constraint finite element models to obtain first-order frequencies of the equivalent constraint finite element models and first-order shape vectors at all the wave measuring points, wherein a finite element model database is compiled from the first-order frequencies and the first-order shape vectors of all the equivalent constraint finite element models; and
an equivalent calculation module, configured to match the first-order frequencies and the first-order displacement vectors of the offshore engineering structure with the first-order frequencies and the first-order shape vectors in the finite element model database respectively, and obtain predicted values of the equivalent scour depths via calculation based on a matching result.

The method and system for predicting the equivalent scour depths of the offshore engineering structure at least have the beneficial technical effects:

1. A traditional means for monitoring the scour depths can only rely on regular detection, and is restricted by weather conditions and the like, resulting in long monitoring cycle and poor accessibility. In the present disclosure, influences of scour are assessed through the change of vibration response above the water surface of the offshore engineering structure, specifically, the equivalent scour depths of the offshore engineering structure are predicted in real time based on vibration acceleration data, monitored in real time, of the offshore engineering structure, which gets rid of the dependence of the existing means for monitoring the scour depths on a multi-beam sweeping survey operation and maintenance vessel, so as to lay a good basis for remote and automatic monitoring of the scour depths.

2. The existing scour monitoring means usually can only acquire the scour depths on soil surfaces, without considering influences of offshore engineering structures with different geological conditions and different pile foundation dimensions on the constraint change of the pile foundation, and analysis on pile-soil interaction and simulation on the soil mass are complex. Therefore, in the present disclosure, the equivalent constraint finite element models are creatively established respectively based on different fixed constraint positions below the mud surface of the offshore engineering structure, the complex pile-soil interaction is equivalently transformed into the fixed constraints on the bottom of the foundation below the mud surface based on a dynamic equivalence principle, the real constraint change of the pile foundation caused by loss of the soil mass around piles caused by scour is measured by the change of the equivalent constraint positions, which avoids complex simulation on the soil mass, and the finite element model database containing the equivalent constraint finite element models, equivalent constraint positions, first-order frequencies and first-order shape vectors is compiled, all of which correspond to one another one to one is formed, which lays a quantization basis for subsequently predicting the equivalent scour depths capable of reflecting the constraint change of the pile foundation caused by scour.

3. In the prior art, the influences of scour on the dynamic response change of the offshore engineering structure are measured usually by analyzing the change of fundamental vibration frequencies (i.e., first-order frequencies) of the structure alone or analyzing the change of the first-order displacements of the structure alone, however, the fundamental vibration frequencies of the structure are insensitive to change of the scour depths, the accuracy of results obtained by analyzing the change of dynamic response of the structure caused by the scour depths only through the change of the fundamental vibration frequency is low, although the first-order displacements are more sensitive to the change of dynamic response of the structure caused by the scour depths compared to the fundamental vibration frequencies, the recognition accuracy of the first-order displacements is lower than that of the fundamental vibration frequencies. Therefore, in the present disclosure, the first-order frequencies and the first-order displacement vectors of the offshore engineering structures match with the first-order frequencies and the first-order shape vectors in the finite element model database, and the predicted values of the equivalent scour depths are obtained via calculation based on the equivalent constraint positions obtained by matching, which not only achieves prediction of the equivalent scour depths capable of reflecting the real constraint change of the pile foundation structure, but also adopt the first-order frequencies and the first-order displacements as parameters for measuring the foundation constraint change caused by scour, thereby effectively decreasing prediction deviations caused by information from a single source and improving the reliability of equivalent scour depth prediction.

Other characteristics and advantages of the present disclosure will be disclosed in following specific implementations and drawings in detail.

### BRIEF DESCRIPTION OF THE DRAWINGS

The present disclosure will be further described below with reference to the drawings.

FIG. 1 is a flowchart of a method for predicting equivalent scour depths of an offshore engineering structure according to an embodiment of the present disclosure.

FIG. 2 is a flowchart of a method for predicting equivalent scour depths of an offshore engineering structure according to an embodiment of the present disclosure.

FIG. 3 is a schematic principle diagram of establishing an equivalent constraint finite element model according to an embodiment of the present disclosure.

FIG. 4 is a flowchart of a method for predicting equivalent scour depths of an offshore engineering structure according to an embodiment of the present disclosure.

FIG. 5 is a flowchart of a method for predicting equivalent scour depths of an offshore engineering structure according to an embodiment of the present disclosure.

FIG. 6 is a schematic diagram of a change trend of equivalent scour depths over time in the prior art according to an embodiment of the present disclosure.

FIG. 7 is a schematic diagram of a trend of equivalent scour depths over time obtained by using the technical solution in the present disclosure according to an embodiment of the present disclosure.

FIG. 8 is a schematic structural diagram of a system for predicting equivalent scour depths of an offshore engineering structure according to an embodiment of the present disclosure.

### DETAILED DESCRIPTION OF THE EMBODIMENTS

The technical solutions in the embodiments of the present disclosure will be explained and described below with reference to the drawings in the embodiments of the present disclosure, however, the following embodiments are merely preferred embodiments of the present disclosure, rather than all of the embodiments of the present disclosure. All other embodiments obtained by those skilled in the art without involving inventive efforts based on the embodiments in the implementations fall within the protection scope of the present disclosure.

In the following description, orientation or position relationships indicated by the terms “inside”, “outside”, “top”, “bottom”, “left”, “right” and the like are only used for conveniently describing the embodiments and simplifying the description, but are not intended to indicate or imply that indicated devices or elements must be in specific orientations or structured and operated in specific orientations, and thus should not be understood as limitations to the present disclosure.

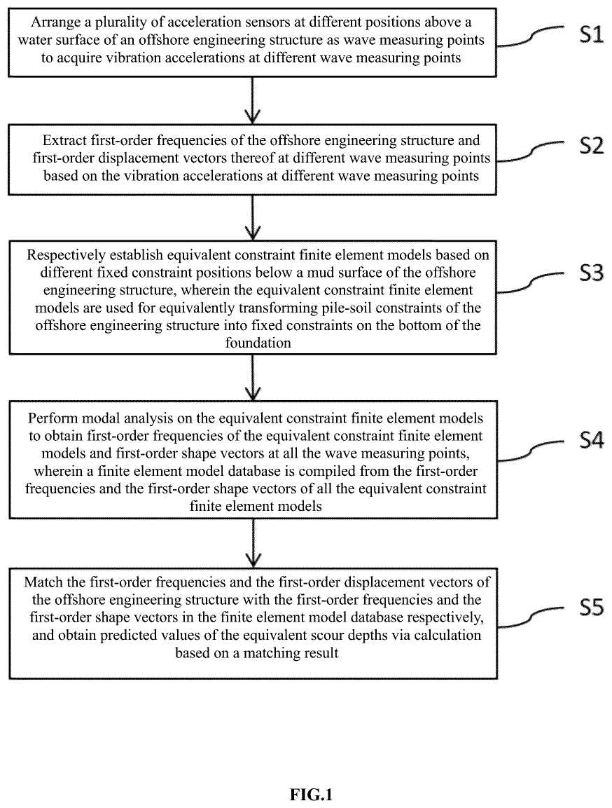

Referring to FIG. 1, FIG. 1 is a flowchart of a method for predicting equivalent scour depths of an offshore engineering structure according to an embodiment of the specification.

As shown in FIG. 1, the method for predicting the equivalent scour depths of the offshore engineering structure at least may include the following steps:

step S1, a plurality of acceleration sensors are arranged at different positions above a water surface of the offshore engineering structure as wave measuring points to acquire vibration accelerations at different wave measuring points.

Specifically, N acceleration sensors are arranged at different positions above the water surface of the offshore engineering structure, and N wave measuring points are generated, where, N≥2.

Step S2, first-order frequencies of the offshore engineering structure and first-order displacement vectors thereof at different wave measuring points are extracted based on the vibration accelerations at different wave measuring points.

Wherein, the first-order frequencies refer to fundamental vibration frequencies of the offshore engineering structure during vibration, which are inherent frequencies of a structural system and reflect fundamental vibration characteristics of the structure during vibration. First-order displacements refer to displacement components in a case where the offshore engineering structure vibrates at the first-order frequencies as vibration frequencies, which reflect a vibration magnitude of the structure at the first-order frequencies. The first-order displacement vectors are formed by a set of the first-order displacements at the same moment and different wave measuring point positions. Both the first-order frequencies and the first-order displacements can reflect vibration characteristics and dynamic response characteristics of the structure.

Furthermore, an implementing manner of extracting the first-order frequencies of the offshore engineering structure and the first-order displacement vectors at different wave measuring points based on the vibration accelerations at different wave measuring points is:

Firstly, the acquired vibration acceleration yₖ is expressed as a form of a complex exponential:

$${y}_{k} = {\sum }_{r = 1}^{{P}_{r}} {A}_{r} {e}^{i {θ}_{r}} {e}^{( - {ξ}_{r} + i {ω}_{r} ) k Δ t} \qquad ( 1 )$$

Where, yₖ represents an acceleration signal at a moment t=kΔt, k=0, 1, 2, . . . , K−1, K represents a length of the acceleration signal used for decomposition, Δt represents a sampling time interval, Pᵣ represents the quantity of complex exponential components forming the acceleration signal, Aᵣ represents an amplitude of an rth complex exponential component forming the acceleration signal, θᵣ represents an initial phase of the rth complex exponential component forming the acceleration signal, ξᵣ represents an attenuation coefficient of the rth complex exponential component forming the acceleration signal, and ωᵣ represents a frequency of the complex exponential component forming the acceleration signal.

Then, since the complex exponential components decomposed from the acceleration signal contain a first-order response of the offshore engineering structure, the first-order frequency f_{c} of the offshore engineering structure may be represented as:

$${f}_{c} = \frac{\vert - {ξ}_{r} + i {ω}_{r} \vert}{2 π} \qquad ( 2 )$$

A first-order acceleration y_{k_c} of the structure may be represented as:

$${y}_{k \_ c} = {A}_{c} {e}^{i {θ}_{c}} {e}^{( - {ξ}_{c} + i {ω}_{c} ) k Δ t} \qquad ( 3 )$$

Then, the first-order acceleration is subjected to secondary integration, and the first-order displacement x_{k_c} can be obtained:

$${x}_{k \_ c} = \frac{{A}_{c}}{{( - {ξ}_{c} + i {ω}_{c} )}^{2}} {e}^{i {θ}_{c}} {e}^{( - {ξ}_{c} + i {ω}_{c} ) k Δt} \qquad 4 )$$

The first-order displacement vector x_{k_cN} at the same moment can be obtained based on the vibration accelerations of N wave measuring points:

$${X}_{k \_ cN} = [ {x}_{k \_ c 1} , {x}_{k \_ c 1} , … , {x}_{k \_ cN} ] \qquad 5 )$$

Errors caused by extraction of modal components can be effectively avoided by extracting the first-order frequencies and the first order displacements with simple deformation patterns from the vibration accelerations represented in the form of complex exponentials. Specifically, representing the vibration accelerations in the form of the complex exponentials is equivalent to decomposing the vibration signals into a series of simple single-frequency vibrations, where vibration amplitudes are the superposition of sine or cosine functions that vary exponentially.

Step S3, equivalent constraint finite element models are respectively established based on different fixed constraint positions below a mud surface of the offshore engineering structure, wherein the equivalent constraint finite element models are used for equivalently transforming pile-soil constraints of the offshore engineering structure into fixed constraints on the bottom of the foundation;
wherein, finite element models are engineering analysis methods used for performing numerical analysis and simulation on structures, parts or systems. The finite element models are mathematical models established based on a finite element method (FEM) principle and technology, which obtain dynamic characteristics of a structure (system) or numerical solutions of physical quantities such as stress, strain and displacement under the action of force bearing by decomposing the complex structure or system into a limited quantity of simple units (such as triangles, quadrangles or hexahedrons), and then modeling and analyzing these units through a mathematical method.

It can be understood that the fixing of a pile foundation of the whole offshore engineering structure is implemented by mainly relying on embedding the pile foundation in soil, so as to improve bearing capacity of the structure, and therefore, a position between a position below the mud surface of the offshore engineering structure and a bottom end of a design pile length of the offshore engineering structure is constrained by the soil mass. However, since analysis on pile-soil interaction and simulation on the soil mass are complex, in the embodiment, the equivalent constraint finite element models are respectively established based on different fixed constraint positions below the mud surface of the offshore engineering structure, that is, a plurality of finite element models of the offshore engineering structure that have different fixed constraint positions of the foundation are established and equivalently transform the pile-soil constraints of the offshore engineering structure into the fixed constraints on the bottom of the foundation.

Step S4, modal analysis is performed on the equivalent constraint finite element models to obtain first-order frequencies of the equivalent constraint finite element models and first-order shape vectors at all the wave measuring points, and a finite element model database is compiled from the first-order frequencies and the first-order shape vectors of all the equivalent constraint finite element models;

wherein, first-order shapes refer to vibration patterns in a case where the offshore engineering structure vibrates at the first-order frequencies. Modal analysis on the finite element models cannot directly obtain the first-order displacements via analysis, for the reason that the first-order displacements are time-varying physical quantities, which can be accurately described by considering a load level of the structure, while the finite element models are usually mathematical models established based on discretization of the units, modal information, including frequencies and shapes, of the structure is obtained by modal analysis on the finite element models, analysis results of the finite element models are expressed in modal space, and global first-order displacements cannot be obtained. Therefore, in the embodiment, the first-order shapes are adopted as a quantization basis for subsequently matching with the first-order displacements of the offshore engineering structure to predict the equivalent scour depths. The first-order shape vectors are formed by a set of the first-order shapes at different wave measuring point positions.

In the embodiment, the first order frequency f₁ in the finite element model database may be represented as:

$${f}_{1} = [ \begin{matrix}{f}_{1 \_ 1} & {f}_{1 \_ 2} & … & {f}_{1 \_ q} ]\end{matrix} \qquad ( 6 )$$

Where, f_{1_1} represents a first-order frequency of a first equivalent constraint finite element model, and q represents the total number of the equivalent constraint finite element models in the finite element model database.

The first-order shape vector Φ₁ in the finite element model database may be represented as:

$${ϕ}_{1} = [ \begin{matrix}{ϕ}_{1 \_ 1} & {ϕ}_{1 \_ 2} & … & {ϕ}_{1 \_ q}\end{matrix} ] = [ \begin{matrix}{ϕ}_{1 \_ 11} & {ϕ}_{1 \_ 12} & … & {ϕ}_{1 \_ 1 q} \\ {ϕ}_{1 \_ 21} & {ϕ}_{1 \_ 22} & … & {ϕ}_{1 \_ 2 q} \\ ⋮ & ⋮ & ⋱ & ⋮ \\ {ϕ}_{1 \_ N 1} & {ϕ}_{1 \_ N 2} & … & {ϕ}_{1 \_ Nq}\end{matrix} ] \qquad ( 7 )$$

Where, ϕ_{1_1} represents a first order shape vector of the first equivalent constraint finite element model, ϕ_{1_1}=[ϕ_{1_11} ϕ_{1_21} . . . ϕ_{1_N1}], N represents a total of the wave measuring points, namely, a total of the acceleration sensors arranged at different positions above the water surface of the offshore engineering structure, ϕ_{1_11} represents a value measured from the first equivalent constraint finite element model at a first wave measuring point for the first-order shape vector, and q represents the total number of the equivalent constraint finite element models in the finite element model database.

Step S5, the first-order frequencies and the first-order displacement vectors of the offshore engineering structure match with the first-order frequencies and the first-order shape vectors in the finite element model database respectively, and predicted values of the equivalent scour depths are obtained via calculation based on a matching result.

A technical concept of the embodiment is as follows: On the basis of the constraint change of a pile foundation of the offshore engineering structure caused by scour, resulting in change in vibration response characteristics of the structure, in the embodiment, firstly, the plurality of acceleration sensors are arranged at different positions above the water surface of the offshore engineering structure as the wave measuring points to measure dynamic response of the structure under the action of wind waves and other marine environments and acquire the vibration accelerations at different wave measuring points, such that the first-order frequencies and the first-order displacements that reflect dynamic characteristics of the structure are extracted therefrom; secondly, the pile-soil constraints represent constraints of soil mass on the pile foundation of the offshore engineering structure, the pile foundation of the offshore engineering structure is embedded into soil of a sea bed, which bears a weight and external loads of the structure through interaction with the soil mass, however, analysis on the interaction between piles and soil and simulation on the soil mass are complex, therefore, the equivalent constraint finite element models are established respectively based on different fixed constraint positions below the mud surface of the offshore engineering structure, the pile-soil constraints are equivalently transformed into the fixed constraints, namely, equivalent constraint positions, on the bottom of the foundation below the mud surface based on a dynamic equivalence principle, and the real constraint change of the pile foundation caused by loss of the soil mass around the piles caused by scour is measured by change in the equivalent constraint positions; then, modal analysis is performed on the equivalent constraint finite element models, to obtain the first-order frequencies of the equivalent constraint finite element models and the first-order shape vectors at all the wave measuring points, the finite element model database is compiled from the first-order frequencies and the first-order shape vectors of all the equivalent constraint finite element models, that is, the finite element model database includes the equivalent constraint finite element models, equivalent constraint positions, first-order frequencies and first-order shape vectors, all of which correspond to one another one by one, thereby providing a quantization basis for subsequently predicting the equivalent scour depths reflecting the constraint change of the pile foundation caused by scour; and finally, the first-order frequencies and the first-order displacement vectors of the offshore engineering structure match with the first-order frequencies and the first-order shape vectors in the finite element model database respectively, that is, the first-order frequencies and the first-order displacement vectors of the offshore engineering structure match with the equivalent constraint finite element models, equivalent constraint positions, first-order frequencies and first-order shape vectors that are in one-to-one correspondence in the finite element model database respectively, and the predicted values of the equivalent scour depths capable of reflecting the real constraint change of the pile foundation structure are obtained via quantitative calculation based on the equivalent constraint positions obtained via matching.

The embodiment at least has the following beneficial technical effects:

1. A traditional means for monitoring the scour depths can only rely on regular detection, and is restricted by weather conditions and the like, resulting in long monitoring cycle and poor accessibility. In the embodiment, influences of scour are assessed through the change of vibration response above the water surface of the offshore engineering structure, specifically, the equivalent scour depths of the offshore engineering structure are predicted in real time based on vibration acceleration data, monitored in real time, of the offshore engineering structure, which gets rid of the dependence of the existing means for monitoring the scour depths on a multi-beam sweeping survey operation and maintenance vessel, so as to lay a good basis for remote and automatic monitoring of the scour depths.

2. The existing scour monitoring means usually can only acquire the scour depths on soil surfaces, without considering influences of offshore engineering structures with different geological conditions and different pile foundation dimensions on the constraint change of the pile foundation, and analysis on pile-soil interaction and simulation on the soil mass are complex. Therefore, in the embodiment, the equivalent constraint finite element models are creatively established respectively based on different fixed constraint positions below the mud surface of the offshore engineering structure, the complex pile-soil interaction is equivalently transformed into the fixed constraints on the bottom of the foundation below the mud surface based on a dynamic equivalence principle, the real constraint change of the pile foundation caused by loss of the soil mass around piles caused by scour is measured by the change of the equivalent constraint positions, which avoids complex simulation on the soil mass, and the finite element model database containing the equivalent constraint finite element models, equivalent constraint positions, first-order frequencies and first-order shape vectors is compiled, all of which correspond to one another one to one is formed, which lays a quantization basis for subsequently predicting the equivalent scour depths capable of reflecting the constraint change of the pile foundation caused by scour.

3. In the prior art, the influences of scour on the dynamic response change of the offshore engineering structure are measured usually by analyzing the change of fundamental vibration frequencies (i.e., first-order frequencies) of the structure alone or analyzing the change of the first-order displacements of the structure alone, however, the fundamental vibration frequencies of the structure are insensitive to the change of the scour depths, the accuracy of results obtained by analyzing the change of dynamic response of the structure caused by the scour depths only through the change of the fundamental vibration frequency is low, although the first-order displacements are more sensitive to the change of dynamic response of the structure caused by the scour depths compared to the fundamental vibration frequencies, the recognition accuracy of the first-order displacements is lower than that of the fundamental vibration frequencies. Therefore, in the embodiment, the first-order frequencies and the first-order displacement vectors of the offshore engineering structures match with the first-order frequencies and the first-order shape vectors in the finite element model database, and the predicted values of the equivalent scour depths are obtained via calculation based on the equivalent constraint positions obtained by matching, which not only achieves prediction of the equivalent scour depths capable of reflecting the real constraint change of the pile foundation structure, but also adopt the first-order frequencies and the first-order displacements as parameters for measuring the foundation constraint change caused by scour, thereby effectively decreasing prediction deviations caused by information from a single source and improving the reliability of equivalent scour depth prediction.

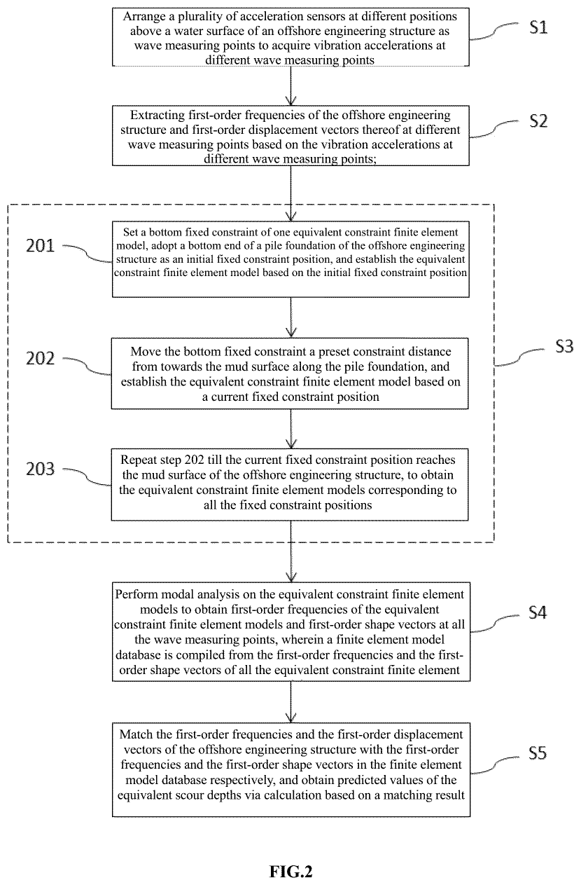

Referring to FIG. 2, FIG. 2 is a flowchart of a method for predicting equivalent scour depths of an offshore engineering structure according to another embodiment of the specification.

As shown in FIG. 2, in the method for predicting the equivalent scour depths of the offshore engineering structure, a method for respectively establishing equivalent constraint finite element models based on different fixed constraint positions below a mud surface of the offshore engineering structure in step S3 at least includes the following steps:
step 201, a bottom fixed constraint of one equivalent constraint finite element model is set, a bottom end of a pile foundation of the offshore engineering structure is adopted as an initial fixed constraint position, and the equivalent constraint finite element model is established based on the initial fixed constraint position;
step 202, the bottom fixed constraint is moved a preset constraint distance towards the mud surface along the pile foundation, and the equivalent constraint finite element model is established based on a current fixed constraint position; and
step 203, step 202 is repeated till the current fixed constraint position reaches the mud surface of the offshore engineering structure, to obtain the equivalent constraint finite element models corresponding to all the fixed constraint positions.

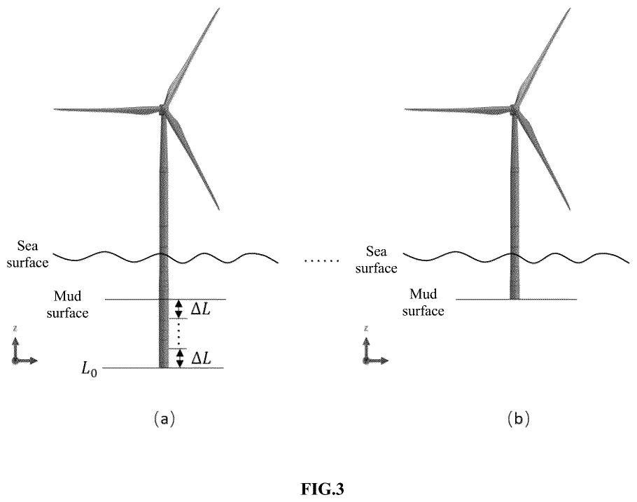

For example, referring to FIG. 3, equivalent constraint finite element models of a wind turbine are established by taking a mono-pile foundation wind turbine as an example, bottom fixed constraints of the equivalent constraint finite element models are set, a bottom end of a pile foundation of the wind turbine is adopted as an initial fixed constraint position L₀, one equivalent constraint finite element model is established based on the initial fixed constraint position L₀, the first equivalent constraint finite element model is shown in FIG. 3 (a), the bottom fixed constraint is moved a preset constraint distance ΔL towards the mud surface along the pile foundation every time, the equivalent constraint finite element model is established based on the current fixed constraint position, the q equivalent constraint finite element models of the structure are obtained in total by continuously changing the constraint positions till the mud surface, and the qth equivalent constraint finite element model of the structure is shown in FIG. 3 (b).

In one embodiment of the specification, an expression of the fixed constraint position of any one equivalent constraint finite element model is:

$$L ( j ) = {L}_{θ} + ( j - 1 ) Δ L \cdot j = 1 , 2 , … , q \qquad ( 8 )$$

Where, L(j) represents the fixed constraint position of the equivalent constraint finite element model, L₀ represents the initial fixed constraint position, ΔL represents the preset constraint distance of movement, q represents the total number of the equivalent constraint finite element models, and j represents indexes of the equivalent constraint finite element models. It can be understood that in general, the indexes represent serial numbers or identifiers, used for uniquely identifying positions or sequences of data, documents or entities.

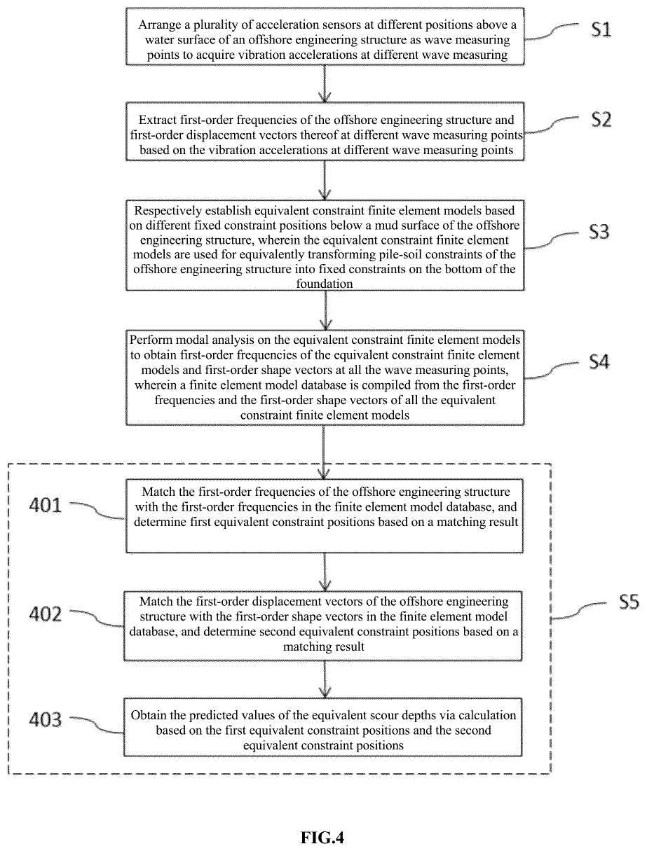

Referring to FIG. 4, FIG. 4 is a flowchart of a method for predicting equivalent scour depths of an offshore engineering structure according to yet another embodiment of the specification.

As shown in FIG. 4, in the method for predicting the equivalent scour depths of the offshore engineering structure, a method for matching the first-order frequencies and the first-order displacement vectors of the offshore engineering structure with the first-order frequencies and the first-order shape vectors in the finite element model database respectively, and obtaining predicted values of the equivalent scour depths via calculation based on a matching result in step S5 at least includes the following steps:
step 401, the first-order frequencies of the offshore engineering structure match with the first-order frequencies in the finite element model database, and first equivalent constraint positions are determined based on a matching result;
step 402, the first-order displacement vectors of the offshore engineering structure match with the first-order shape vectors in the finite element model database, and second equivalent constraint positions are determined based on a matching result; and
step 403, the predicted values of the equivalent scour depths are obtained via calculation based on the first equivalent constraint positions and the second equivalent constraint positions.

Specifically, in the embodiment, the first-order frequencies of the offshore engineering structure match with the first-order frequencies in the finite element model database, that is, the first-order frequencies of the offshore engineering structure match with the equivalent constraint finite element models, equivalent constraint positions and first-order frequencies, all of which correspond to one another one to one, in the finite element model database, matching methods include, but are not limited to a one-to-one correspondence method, a minimum absolute error method, a minimum relative error method and the like, which are not limited in the embodiment, the first equivalent constraint positions are determined based on the matching result, and the first equivalent constraint positions represent equivalent constraint positions based on the matching of the first-order frequencies. The first-order displacements and the first-order shapes are used for describing response characteristics of the structure under a dynamic action, the first-order displacements can be used for monitoring actual response characteristics of the structure, the first-order shapes in the finite element model database can be used for simulating theoretical response characteristics of the structure, therefore, in the embodiment, the first-order displacement vectors of the offshore engineering structure match with the first-order shape vectors in the finite element model database, that is, the first-order displacement vectors of the offshore engineering structure match with the equivalent constraint finite element models, equivalent constraint positions and first-order shape vectors, all of which correspond to one another one to one, in the finite element model database, the second equivalent constraint positions are determined based on the matching result, and the second equivalent constraint positions represent equivalent constraint positions based on the matching of the first-order displacements. Then, the predicted values of the equivalent scour depths are obtained via calculation based on the first equivalent constraint positions and the second equivalent constraint positions, that is, by considering the first-order frequencies and the first-order displacements at the same time. For example, methods for obtaining the predicted values of the equivalent scour depths via calculation may include the following several types, which are not limited in the embodiment:

1. The first equivalent constraint positions and the second equivalent constraint positions are subjected to weighted summation, to obtain equivalent constraint positions that take the first-order frequencies and the first-order displacements into account at the same time, denoted as the predicted values of the equivalent scour depths.

2. A mapping relationship is obtained via network training through an artificial neural network model by adopting the first equivalent constraint positions and the second equivalent constraint positions as input nodes and adopting the equivalent scour depths as output nodes, such that the predicted values of the equivalent scour depths are obtained.

3. Fuzzy sets of the first equivalent constraint positions and the second equivalent constraint positions are mapped into fuzzy sets of the scour depths based on a fuzzy logic theory, and predicted results of the equivalent scour depths are obtained via fuzzy logic inference.

By means of the method for predicting the equivalent scour depths of the offshore engineering structure in the embodiment, not only prediction of the equivalent scour depths capable of reflecting the real constraint change of the pile foundation structure is achieved, but also the first-order frequencies and the first-order displacements are adopted as parameters for measuring the foundation constraint change caused by scour, and the predicted values of the equivalent scour depths are obtained via calculation through certain calculation methods, thereby effectively decreasing prediction deviations caused by information from a single source and improving the reliability of the equivalent scour depth prediction.

In one embodiment of the specification, matching the first-order frequencies of the offshore engineering structure with the first-order frequencies in the finite element model database, and determining first equivalent constraint positions based on a matching result in step 401, include:
relative errors between the first-order frequencies of the offshore engineering structure and the first-order frequencies in the finite element model database are calculated one by one, and indexes of the equivalent constraint finite element models corresponding to the current first-order frequencies in the finite element model database are determined when the relative error is the minimum; and
fixed constraint positions of the equivalent constraint finite element models determined based on a first-order frequency matching result are obtained according to the indexes, denoted as the first equivalent constraint positions.

Specifically, in the embodiment, an implementing manner for determining the first equivalent constraint positions is:
When relative errors between the first order frequencies of the offshore engineering structure and the first-order frequencies in the finite element model database are the minimum, the index ID_{f} of the corresponding equivalent constraint finite element model may be represented as:

$${ID}_{f} = arg min ( \frac{{f}_{c}}{{f}_{1}} - 1 ) \qquad ( 9 )$$

Where, f_{c} represents the first-order frequency of the offshore engineering structure, as shown in Formula (2), and f₁ represents the first-order frequency in the finite element model database, as shown in Formula (6); and

Formula (9) is substituted into Formula (8), and in the event of j=ID_{f}, the equivalent constraint positions based on the matching of the first-order frequency, namely, the first equivalent constraint positions can be obtained, and the first equivalent constraint positions L_{f} may be represented as:

$${L}_{f} = L ( {ID}_{f} ) \qquad ( 10 )$$

Considering that the first-order frequencies of the offshore engineering structure are very close to the first-order frequencies in the finite element model database in the actual condition, the subtraction of the first-order frequencies in the finite element model database from the first-order frequencies of the offshore engineering structure may lead to numerical instability in errors, therefore, in the embodiment, the relative errors are calculated by dividing the first-order frequencies of the offshore engineering structure by the first-order frequencies in the finite element model database and then subtracting 1 therefrom, which can better meet actual application requirements, improve accuracy of the matching result to a certain degree, and thus obtain the more accurate first equivalent constraint positions.

In one embodiment of the specification, matching the first-order displacement vectors of the offshore engineering structure with the first-order shape vectors in the finite element model database, and determining second equivalent constraint positions based on a matching result, include:
the first-order displacement vectors of the offshore engineering structure and the first-order shape vectors in the finite element model database are normalized;
relative errors between normalized first-order displacements of the offshore engineering structure and normalized first-order shapes in the finite element model database are calculated one by one, and indexes of the equivalent constraint finite element models corresponding to the current first-order shapes are determined when the relative error is the minimum; and
fixed constraint positions of the equivalent constraint finite element models determined based on a first-order displacement matching result are obtained according to the indexes, denoted as the second equivalent constraint positions.

Specifically, in the embodiment, an implementing manner for determining the second equivalent constraint positions is:

Firstly, since the first-order displacements extracted from the measured vibration acceleration data are dimensional, in the embodiment, in order to contrast and match it with the first shapes in the finite element model database, the first-order displacements extracted from the measured data and the first-order shapes in the finite element model database are respectively normalized with reference to a certain standard. Wherein, normalization refers to dividing numerical values of the vectors by a reference value, to transform different vectors into a normalized form, which is conducive to comparison.

Furthermore, normalizing the first-order displacement vectors of the offshore engineering structure and the first-order shape vectors in the finite element model database, includes:
the first-order displacement vectors of the offshore engineering structure are normalized based on first-order displacements, extracted at the wave measuring point closest to the water surface, of the offshore engineering structure; and
the first-order shape vector of each equivalent constraint finite element model in the finite element model database is normalized based on the first-order shape, obtained at the wave measuring point closest to the water surface, of each equivalent constraint finite element model.

Then, relative errors between normalized first-order displacements of the offshore engineering structure and normalized first-order shapes in the finite element model database are calculated one by one. When relative errors between the first order frequencies of the offshore engineering structure and the first-order frequencies in the finite element model database are the minimum, the index ID_{ϕ} of the corresponding equivalent constraint finite element model may be represented as:

$${ID}_{ϕ} = arg min ( \begin{matrix}{\sum }_{i = 2}^{N} \vert \frac{\frac{{x}_{k \_ c i}}{{x}_{k \_ c 1}}}{\frac{{ϕ}_{1 \_ f 1}}{{ϕ}_{1 \_ 11}}} - 1 \vert & {\sum }_{i = 2}^{N} \vert \frac{\frac{{x}_{k \_ c i}}{{x}_{k \_ c 1}}}{\frac{{ϕ}_{1 \_ i 2}}{{ϕ}_{1 \_ 12}}} - 1 \vert & … & {\sum }_{i = 2}^{N} \vert \frac{\frac{{x}_{k \_ c i}}{{x}_{k \_ c 1}}}{\frac{{ϕ}_{1 \_ iq}}{{ϕ}_{1 \_ 1 q}}} - 1 \vert\end{matrix} ) \qquad ( 11 )$$

Where, N represents a total of the wave measuring points, namely, a total of the acceleration sensors arranged at different positions above the water surface of the offshore engineering structure, x_{k_ci} represents a first-order displacement, extracted at an ith wave measuring point, of the offshore engineering structure, x_{k_c1} represents a first-order displacement, extracted at a wave measuring point closest to the water surface, of the offshore engineering structure, q represents the total number of the equivalent constraint finite element models in the finite element model database, ϕ_{1_iq} represents a first-order shape value, obtained at an ith wave measuring point, of a qth equivalent constraint finite element model, ϕ_{1_11} represents a first-order shape value, obtained at the wave measuring point closest to the water surface, of the first equivalent constraint finite element model, and ϕ_{1_1q} represents a first-order shape value, obtained at the wave measuring point closest to the water surface, of the qth equivalent constraint finite element model.

Formula (11) is substituted into Formula (8), and in the event of J=ID_{ϕ}, the equivalent constraint positions based on the matching of the first-order displacements, namely, the second equivalent constraint positions can be obtained, and the second equivalent constraint positions L_{ϕ} may be represented as:

$${L}_{ϕ} = L ( {ID}_{ϕ} ) \qquad ( 12 )$$

Considering that the first-order shapes of the offshore engineering structure are very close to the first-order shapes in the finite element model database in the actual condition, the subtraction of the first-order shapes in the finite element model database from the first-order shapes of the offshore engineering structure may lead to numerical instability in errors, therefore, in the embodiment, the relative errors are calculated by dividing the normalized first-order shapes of the offshore engineering structure by the normalized first-order shapes in the finite element model database and then subtracting 1 therefrom, which can better meet actual application requirements, improve accuracy of the matching result to a certain degree, and thus obtain the more accurate second equivalent constraint positions.

In one embodiment of the specification, obtaining the predicted values of the equivalent scour depths via calculation based on the first equivalent constraint positions and the second equivalent constraint positions, includes:
weighted summation is performed on the first equivalent constraint positions and the second equivalent constraint positions, to obtain equivalent constraint positions that take the first-order frequencies and the first-order displacements into account at the same time, denoted as the predicted values of the equivalent scour depths.

Specifically, the predicted values L_{fϕ} of the equivalent scour depths may be represented as:

$${L}_{f ϕ} = {aL}_{f} + b {L}_{ϕ} \qquad ( 13 )$$

Where, L_{f} represents the first equivalent constraint position, a represents a preset weight of the first equivalent constraint position, L_{ϕ} represents the second equivalent constraint position, and b represents a preset weight of the second equivalent constraint position.

Compared to methods such as training a complex neural network model or performing fuzzy logic inference, in the embodiment, the equivalent constraint positions taking the first-order frequencies and the first-order displacements into account at the same time are calculated as the predicted values of the equivalent scour depths through the weighted summation method, and the method is lower in calculation complexity, higher in operation speed and especially suitable for application scenes with high requirements for real-time performance. Moreover, the calculation method adopted for the embodiment has high flexibility and controllability, and the degree of influence of the equivalent constraint positions based on the first-order frequencies and the equivalent constraint positions based on the first-order displacements on the predicted values of the equivalent scour depths can be directly adjusted by adjusting the preset weights, so that the requirements for adaptively adjusting the predicted results of the equivalent scour depths in actual engineering are met.

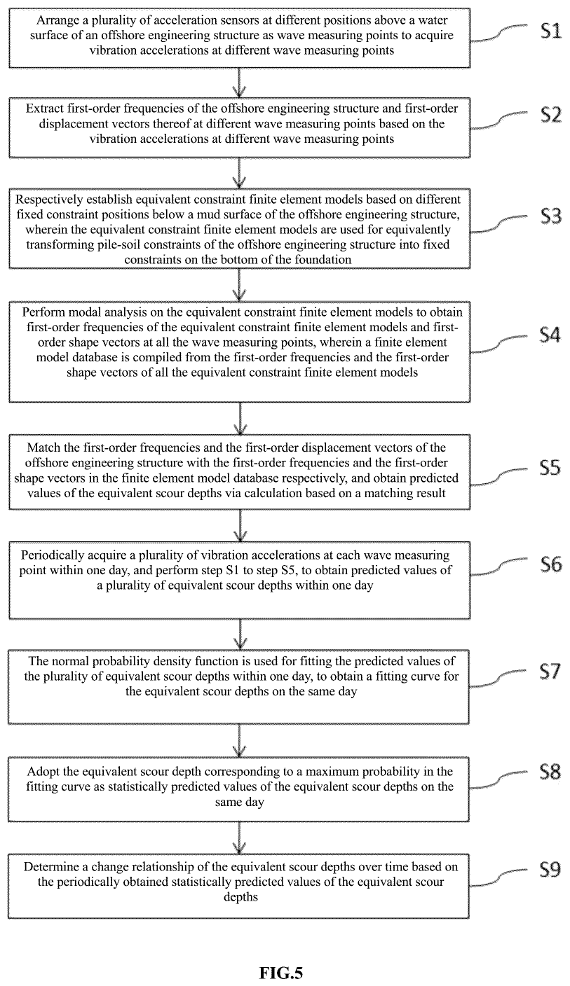

Referring to FIG. 5, FIG. 5 is a flowchart of a method for predicting equivalent scour depths of an offshore engineering structure according to yet another embodiment of the specification.

As shown in FIG. 5, the method for predicting the equivalent scour depths of the offshore engineering structure further includes the following steps after step S5:
step S6, a plurality of vibration accelerations at each wave measuring point within one day are periodically acquired, and step S1 to step S5 are performed, to obtain predicted values of a plurality of equivalent scour depths within one day;
step S7, the normal probability density function is used for fitting the predicted values of the plurality of equivalent scour depths within one day, to obtain a fitting curve for the equivalent scour depths on the same day;
step S8, the equivalent scour depth corresponding to a maximum probability in the fitting curve is adopted as a statistically predicted value of the equivalent scour depths on the same day; and
step S9, a change relationship of the equivalent scour depths over time is determined based on the periodically obtained statistically predicted value of the equivalent scour depths.

Specifically, an implementing manner of the embodiment is:
Firstly, the vibration acceleration at each wave measuring point within one day which periodically (for example, three days apart) acquired is segmented, the length of the signal in the single execution step S1 is the length of the segment, assuming that the vibration acceleration is segmented into M segments in total, data of each segment is processed through step S1 to step S5 in sequence, and predicted values of M equivalent scour depths within one day are obtained;
then, the normal probability density function is used for fitting the predicted values of the plurality of equivalent scour depths within one day, to obtain the fitting curve for the equivalent scour depths on the same day, and the probability density function is represented as:

$$f ( {L}_{f ϕ} ) = \frac{1}{\sqrt{2 π} σ} {e}^{- \frac{{( {L}_{f ϕ} - µ )}^{2}}{2 {σ}^{2}}} \qquad ( 14 )$$

where, L_{fϕ} represents a predicted value of one equivalent scour depth within one day, μ represents a mean of the predicted values of the M equivalent scour depths within one day, and σ represents a variance of the predicted values of the M equivalent scour depths within one day;
then, the equivalent scour depth corresponding to the maximum probability in the fitting curve is adopted as the statistically predicted value of the equivalent scour depths on the same day; and
finally, the periodically acquired vibration acceleration data of the offshore engineering structure is processed through step S6 to step S8, the statistically predicted value of the equivalent scour depths in each cycle is obtained, these positions are connected into a curve based on the statistically predicted value of the equivalent scour depths in each cycle, and the change relationship of the equivalent scour depths over time can be obtained, which can reflect the real constraint change of the pile foundation of the offshore engineering structure under the action of current scour while avoiding complex simulation on the soil mass.

Considering prediction errors caused by single prediction, in the embodiment, the vibration acceleration data within one day is subjected to segmented prediction, a plurality of predicted results are statistically analyzed in days, that is, the normal probability density function is used for fitting the plurality of predicted equivalent scour constraint positions within one day, and the equivalent scour depth with the maximum probability in the fitting curve is adopted as the statistically predicted value of the equivalent scour depths on the same day. Therefore, prediction deviations caused by single prediction and interference of measured signal noise can be effectively eliminated, and accurate results can be obtained by the present disclosure under signals with a high noise level, thereby improving the stability and reliability of the equivalent scour depth prediction.

Accuracy of the method for predicting the equivalent scour depths of the offshore engineering structure is verified below through a specific experimental example:

In the experimental example, a typical wind turbine of a wind field in Jiangsu is selected for analysis, the typical wind turbine is a 4.0 MW mono-pile foundation wind turbine, a total length of a foundation is 73 m, a top of the foundation is 19 m away from a mud surface, a tower is 81 m high, fan blades are 146 m in diameter, and the wind turbine is a typical form in current offshore wind power engineering. Five three-axis acceleration sensors are sequentially arranged at different positions from the top end of the foundation to a top of the tower of the wind turbine, and vibration accelerations at five wave measuring points during operation of the wind turbine are acquired by monitoring the wind turbine for a long time. A time range of the experimental example is selected as Jun. 28, 2021 to Aug. 8, 2021, including monitoring data within 43 days, data in one day is extracted every other three days for analysis, and analysis data in 15 days is acquired in total.

The specific experimental steps are as follows:

Firstly, the vibration acceleration data in one day is segmented into M segments in days, 2000 pieces of vibration acceleration data, namely, measured signals, are acquired in each segment for decomposition and reconstruction, and a first-order frequency and a first-order displacement of the mono-pile foundation wind turbine within the segment are obtained. First-order displacements at the same moment of the five wave measuring points are extracted, and corresponding first-order displacement vectors of the mono-pile foundation wind turbine at the moment are obtained accordingly.

Then, 1:1 equivalent constraint finite element models of the mono-pile foundation are established, and bottom fixed constraints of the equivalent constraint finite element models are set. A plurality of corresponding equivalent constraint finite element models are established by continuously changing fixed constraint positions at bottom ends of the finite element models, each equivalent constraint finite element model is subjected to modal analysis, and a series of corresponding first-order frequencies and first-order shape vectors are obtained, to compile a finite element model database in the segment.

Then, the first-order frequencies extracted from the measured signals in the segment match with the first-order frequencies of the equivalent constraint finite element models at different fixed constraint positions in the finite element model database, and an equivalent constraint position corresponding to a minimum relative error of a matching degree is selected as a first equivalent constraint position obtained based on the matching of the first-order frequencies. The first-order displacement vectors extracted from the measured signals in the segment are normalized based on a first wave measuring point (namely, a wave measuring point closest to a water surface), then the normalized first-order displacement vectors match with the first-order shape vectors of the equivalent constraint finite element models at different fixed constraint positions in the finite element model database, and an equivalent constraint position corresponding to a minimum relative error of a matching degree is selected as a second equivalent constraint position obtained based on the matching of the first-order displacements. Equal preset weights are distributed to the first equivalent constraint position and the second equivalent constraint position, that is, a=b=0.5, and predicted values of the equivalent scour depths that take the first-order frequencies and the first-order displacements into account at the same time and are capable of reflecting the real constraint change of a pile foundation structure are obtained.

Then, predicted values of M equivalent scour depths are obtained by respectively analyzing data in M time segments within one day, and then the normal probability density function is used for fitting the predicted values of M equivalent scour depths, and an equivalent scour depth with a maximum probability in a fitting curve is adopted as a statistically predicted value of the equivalent scour depths on the same day. The statistically predicted value of the equivalent scour depths that take the first-order frequencies and the first-order displacements into account at the same time and are capable of reflecting the real constraint change of a pile foundation structure on the same day are obtained by fitting against the normal probability density function.

In addition, compared with the prior art that the influences of scour on the dynamic response change of the offshore engineering structure are measured by analyzing the change of fundamental vibration frequencies (namely, first-order frequencies) of the structure alone, the data in M segments within one day is calculated, M equivalent scour constraint positions only considering the first-order frequencies are obtained, and then fit it use the normal probability density function, and the equivalent scour depths only considering the first-order frequencies on the same day are obtained.

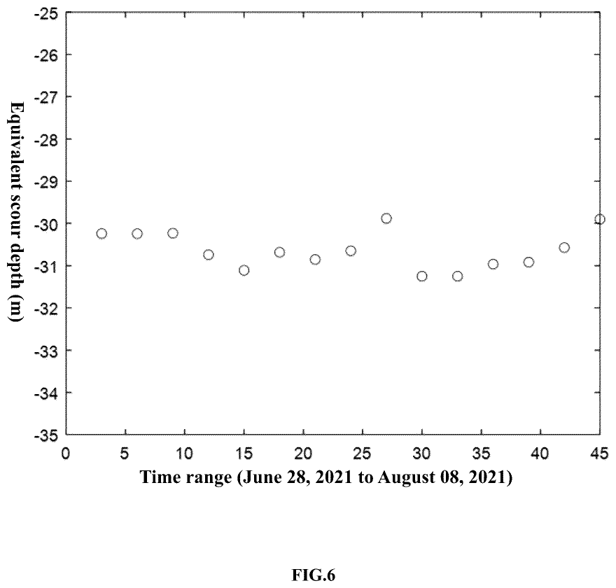

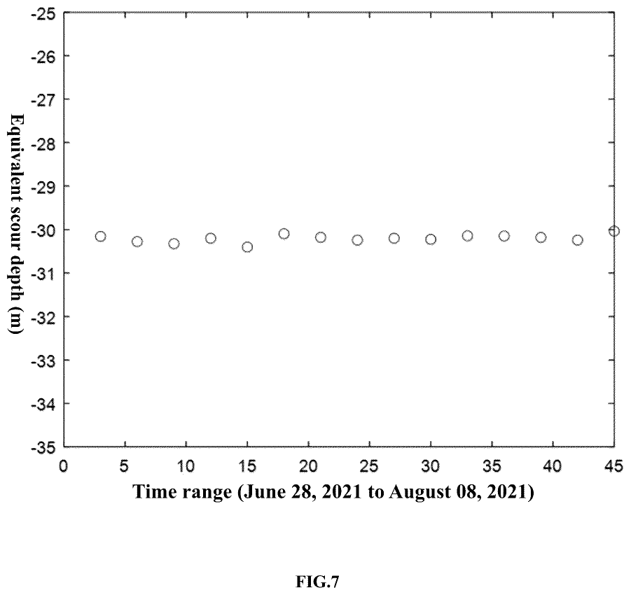

Finally, data in 15 days in a monitoring cycle lasting for 43 days is analyzed in sequence, and a change trend (referring to FIG. 6) of the equivalent scour depths over time using the prior art and a change trend (referring to FIG. 7) of the equivalent scour depths over time using the method for predicting the equivalent scour depths of the offshore engineering structure in the embodiment are obtained.

The equivalent scour depths in FIG. 6 and FIG. 7 are both near a position of −30 m, although actual change conditions are hardly measured, the prediction period is only 43 days, which is short, constraint positions below the mud surface of the structure cannot greatly change under normal conditions, which are about 4.0 times of pile diameter below the mud surface, consistent with constraint positions of a large-diameter mono-pile foundation being 4 to 6 times of pile diameter below the mud surface. It can be shown in contrast that a range of the change trend, corresponding to FIG. 6, of the equivalent scour depths over time using the prior art is 1.37 m, which is obviously wider than a range of the change trend, corresponding to FIG. 7, of the equivalent scour depths over time using the method for predicting the equivalent scour depths of the offshore engineering structure in the embodiment, verifying stability and accuracy of the equivalent scour depths predicted through the method for predicting the equivalent scour depths of the offshore engineering structure in the embodiment, and the method has great significance in assessing a safe state of the offshore engineering structure under scour conditions.

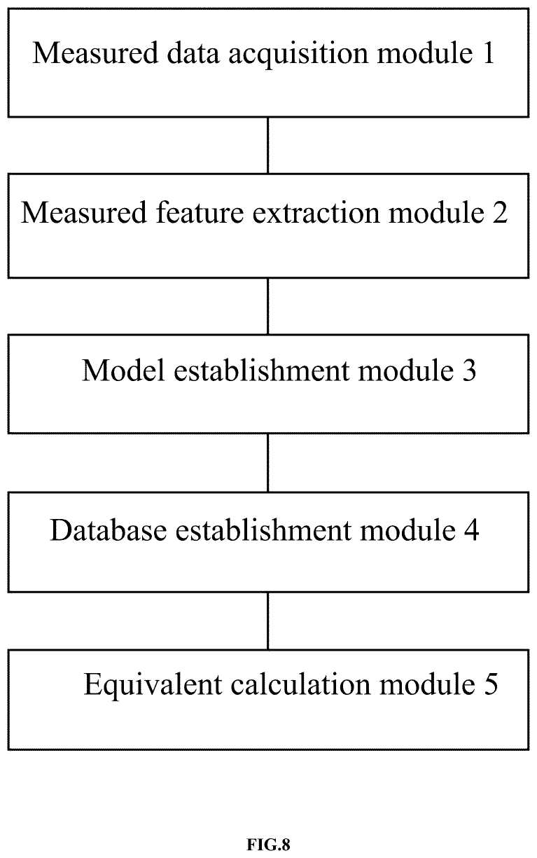

In the other aspect, an embodiment of the present application further provides a system for predicting equivalent scour depths of an offshore engineering structure with a technical concept the same as that of the method for predicting the equivalent scour depths of the offshore engineering structure. Referring to FIG. 8, the system includes:
a measured data acquisition module 1, configured to arrange a plurality of acceleration sensors at different positions above a water surface of the offshore engineering structure as wave measuring points to obtain vibration accelerations at different wave measuring points;
a measured feature extraction module 2, configured to extract first-order frequencies of the offshore engineering structure and first-order displacement vectors thereof at different wave measuring points based on the vibration accelerations at different wave measuring points;
a model establishment module 3, configured to respectively establish equivalent constraint finite element models based on different fixed constraint positions below a mud surface of the offshore engineering structure, wherein the equivalent constraint finite element models are used for equivalently transforming pile-soil constraints of the offshore engineering structure into fixed constraints on the bottom of the foundation;
a database establishment module 4, configured to perform modal analysis on the equivalent constraint finite element models to obtain first-order frequencies of the equivalent constraint finite element models and first-order shape vectors at all the wave measuring points, and a finite element model database is compiled from the first-order frequencies and the first-order shape vectors of all the equivalent constraint finite element models; and
an equivalent calculation module 5, configured to match the first-order frequencies and the first-order displacement vectors of the offshore engineering structure with the first-order frequencies and the first-order shape vectors in the finite element model database respectively, and obtain predicted values of the equivalent scour depths via calculation based on a matching result.

The above descriptions are merely preferred embodiments of the present application and the descriptions of applied technical principles. It should be understood for those skilled in the art that the protection scope involved in the present disclose is not limited to the technical solutions made by specifically combining the above technical characteristics, but also covers other technical solutions made by any combination of the above technical characteristics or equivalent characteristics thereof without departing from the concept of the present disclosure, for example, the technical solutions made by exchanging the above characteristics with the technical characteristics with similar functions disclosed (but not limited to) in the present disclosure.

In addition, although the operations are described in a specific order, it should not be understood that these operations are performed in the specific order indicated as above or in a sequential order. Multitasking and parallel processing may be advantageous in certain environments. Similarly, although a plurality of specific implementation details are included in the above description, they should not be explained as limitations to the scope of the present disclosure. Certain characteristics described in the context of independent embodiments may further be implemented in the single embodiment. On the contrary, various characteristics described in the convex of the single embodiment may also be independently implemented in a plurality of embodiments or implemented therein in any proper sub-combination manner.

What is claimed is:

1. A method for predicting equivalent scour depths of an offshore engineering structure, comprising the following steps:
step S1, arranging a plurality of acceleration sensors at different positions above a water surface of the offshore engineering structure as wave measuring points to acquire vibration accelerations at different wave measuring points;
step S2, extracting first-order frequencies of the offshore engineering structure and first-order displacement vectors thereof at different wave measuring points based on the vibration accelerations at different wave measuring points;
step S3, respectively establishing equivalent constraint finite element models based on different fixed constraint positions below a mud surface of the offshore engineering structure, wherein the equivalent constraint finite element models are used for equivalently transforming pile-soil constraints of the offshore engineering structure into fixed constraints on the bottom of the foundation;
step S4, performing modal analysis on the equivalent constraint finite element models to obtain first-order frequencies of the equivalent constraint finite element models and first-order shape vectors at all the wave measuring points, wherein a finite element model database is compiled from the first-order frequencies and the first-order shape vectors of all the equivalent constraint finite element models; and
step S5, matching the first-order frequencies and the first-order displacement vectors of the offshore engineering structure with the first-order frequencies and the first-order shape vectors in the finite element model database respectively, and obtaining predicted values of the equivalent scour depths via calculation based on a matching result.

2. The method for predicting the equivalent scour depths of the offshore engineering structure according to claim 1, wherein
respectively establishing equivalent constraint finite element models based on different fixed constraint positions below a mud surface of the offshore engineering structure in step S3, comprises:
setting a bottom fixed constraint of one equivalent constraint finite element model, adopting a bottom end of a pile foundation of the offshore engineering structure as an initial fixed constraint position, and establishing the equivalent constraint finite element model based on the initial fixed constraint position;
moving the bottom fixed constraint a preset constraint distance towards the mud surface along the pile foundation, and establishing the equivalent constraint finite element model based on a current fixed constraint position; and
repeating the previous step till the current fixed constraint position reaches the mud surface of the offshore engineering structure, to obtain the equivalent constraint finite element models corresponding to all the fixed constraint positions.

3. The method for predicting the equivalent scour depths of the offshore engineering structure according to claim 2, wherein
an expression of the fixed constraint position of the equivalent constraint finite element model is:
$$L ( j ) = {L}_{0} + ( j - 1 ) Δ L , j = 1 , 2 , … , q$$
where, L(j) represents the fixed constraint position of the equivalent constraint finite element model, L₀ represents the initial fixed constraint position, j represents an index of the equivalent constraint finite element model, ΔL represents the preset constraint distance of movement, and q represents the total number of the equivalent constraint finite element models.

4. The method for predicting the equivalent scour depths of the offshore engineering structure according to claim 1, wherein
the matching the first-order frequencies and the first-order displacement vectors of the offshore engineering structure with the first-order frequencies and the first-order shape vectors in the finite element model database respectively, and obtaining predicted values of the equivalent scour depths via calculation based on a matching result in step S5, comprise:
matching the first-order frequencies of the offshore engineering structure with the first-order frequencies in the finite element model database, and determining first equivalent constraint positions based on a matching result;
matching the first-order displacement vectors of the offshore engineering structure with the first-order shape vectors in the finite element model database, and determining second equivalent constraint positions based on a matching result; and
obtaining the predicted values of the equivalent scour depths via calculation based on the first equivalent constraint positions and the second equivalent constraint positions.

5. The method for predicting the equivalent scour depths of the offshore engineering structure according to claim 4, wherein
the matching the first-order frequencies of the offshore engineering structure with the first-order frequencies in the finite element model database, and determining first equivalent constraint positions based on a matching result, comprise:
calculating relative errors between the first-order frequencies of the offshore engineering structure and the first-order frequencies in the finite element model database one by one, and determining indexes of the equivalent constraint finite element models corresponding to the current first-order frequencies in the finite element model database when the relative error is the minimum; and
obtaining fixed constraint positions of the equivalent constraint finite element models determined based on a first-order frequency matching result according to the indexes, and marking as the first equivalent constraint positions.

6. The method for predicting the equivalent scour depths of the offshore engineering structure according to claim 4, wherein
the matching the first-order displacement vectors of the offshore engineering structure with the first-order shape vectors in the finite element model database, and determining second equivalent constraint positions based on a matching result, comprise:
normalizing the first-order displacement vectors of the offshore engineering structure and the first-order shape vectors in the finite element model database;
calculating relative errors between normalized first-order displacements of the offshore engineering structure and normalized first-order shapes in the finite element model database one by one, and determining indexes of the equivalent constraint finite element models corresponding to the current first-order shapes when the relative error is the minimum; and
obtaining fixed constraint positions of the equivalent constraint finite element models determined based on a first-order displacement matching result according to the indexes, and marking as the second equivalent constraint positions.

7. The method for predicting the equivalent scour depths of the offshore engineering structure according to claim 6, wherein
the normalizing the first-order displacement vectors of the offshore engineering structure and the first-order shape vectors in the finite element model database, comprises:
normalizing the first-order displacement vectors of the offshore engineering structure based on first-order displacements, extracted at the wave measuring point closest to the water surface, of the offshore engineering structure; and
normalizing the first-order shape vector of each equivalent constraint finite element model in the finite element model database based on the first-order shape, obtained at the wave measuring point closest to the water surface, of each equivalent constraint finite element model.

8. The method for predicting the equivalent scour depths of the offshore engineering structure according to claim 4, wherein
the obtaining the predicted values of the equivalent scour depths via calculation based on the first equivalent constraint positions and the second equivalent constraint positions, comprises:
performing weighted summation on the first equivalent constraint positions and the second equivalent constraint positions, to obtain equivalent constraint positions that take the first-order frequencies and the first-order displacements into account at the same time, and marking as the predicted values of the equivalent scour depths.

9. The method for predicting the equivalent scour depths of the offshore engineering structure according to claim 1, wherein
the method further comprises the following steps after step S5:
periodically acquiring a plurality of vibration accelerations at each wave measuring point within one day, and performing step S1 to step S5, to obtain predicted values of a plurality of equivalent scour depths within one day;
the normal probability density function is used for fitting the predicted values of the plurality of equivalent scour depths within one day, to obtain a fitting curve for the equivalent scour depths on the same day;
adopting the equivalent scour depth corresponding to a maximum probability in the fitting curve as statistically predicted values of the equivalent scour depths on the same day; and
determining a change relationship of the equivalent scour depths over time based on the periodically obtained statistically predicted values of the equivalent scour depths.

10. A system for predicting equivalent scour depths of an offshore engineering structure, comprising:
a measured data acquisition module, configured to arrange a plurality of acceleration sensors at different positions above a water surface of the offshore engineering structure as wave measuring points to obtain vibration accelerations at different wave measuring points;
a measured feature extraction module, configured to extract first-order frequencies of the offshore engineering structure and first-order displacement vectors thereof at different wave measuring points based on the vibration accelerations at different wave measuring points;
a model establishment module, configured to respectively establish equivalent constraint finite element models based on different fixed constraint positions below a mud surface of the offshore engineering structure, wherein the equivalent constraint finite element models are used for equivalently transforming pile-soil constraints of the offshore engineering structure into fixed constraints on the bottom of the foundation;
a database establishment module, configured to perform modal analysis on the equivalent constraint finite element models to obtain first-order frequencies of the equivalent constraint finite element models and first-order shape vectors at all the wave measuring points, wherein a finite element model database is compiled from the first-order frequencies and the first-order shape vectors of all the equivalent constraint finite element models; and
an equivalent calculation module, configured to match the first-order frequencies and the first-order displacement vectors of the offshore engineering structure with the first-order frequencies and the first-order shape vectors in the finite element model database respectively, and obtain predicted values of the equivalent scour depths via calculation based on a matching result.
